(19) United States
(12) Patent Application Publication
(10) Pub. No.: US 2002/0028040 A1
(43) Pub. Date: Mar. 7, 2002

(54) All-fiber add/drop filter and method of manufacturing the same

(76) Inventors: Shiao-Min Tseng, Hsinchu (TW); Po-Hsin Chen, Taichung Hsien (TW); Horng-Ching Lai, Tainan Hsien (TW); Nan-Kuang Chen, Taipei Hsien (TW)

Correspondence Address: BIRCH STEWART KOLASCH & BIRCH, PO BOX 747, FALLS CHURCH, VA, 22040-0747, US

(21) Appl. No.: 09/726,492

(22) Filed: Dec. 1, 2000

(30) Foreign Application Priority Data
Sep. 6, 2000 (TW) 89118380

(51) Int. Cl. G02B 6/26; G02B 6/34; G02B 6/35

(52) U.S. Cl. 385/30; 385/24; 385/37

(57) ABSTRACT

The invention relates to an all-fiber add/drop filter. A wide-band light is input one port of a photosensitive fiber and affected by a Bragg grating, and then deviated a Bragg wavelength and a transmission light satisfying the Bragg condition. The Bragg wavelength and transmission light couple from one fiber to the other, wherein the Bragg wavelength is dropped at one port of another optical fiber and the transmission light is added to another port of another optical fiber.

### BACKGROUND OF THE INVENTION

1. Field of the Invention

The invention relates to an all-fiber add/drop filter. In particular, the invention relates to an add/drop filter employing an optical fiber with Bragg gratings.

2. Description of the Related Art

Because of the popularity of the Internet and demands on broad band communication networks, the fiber-optic communication system with higher speed and wider bandwidth becomes more and more critical. To meet these demands, the optical wavelength division multiplexing (WDM) system and dense wavelength division multiplexing (DWDM) system were proposed and implemented.

As shown in FIG. 1A, a four-channel transmission architecture with three low-loss fiber Bragg gratings/optical circulators including one programmable add/drop multiplexer has been constructed and tested. However, the price of each circulator costs about US$1000 and it is too expansive.

In FIG. 1B, a hybrid DWDM device combines fiber Bragg grating and dielectric-coated band-pass filters and can meet required specification in various cost-effective structures. However, it is hard to align the fiber gratings on the two arms of the fiber coupler.

FIG. 2 shows an optical circuit of a 16×32 arrayed-waveguide grating [see “16×32 AWG with Cyclic-Frequency Response”, by K. Maru et. al., Third Optoelectronics and Communications Conference (OECC'98) Technical Digest, pp. 54-55, July 1998, Makuhari Messe]. However, it also has an alignment problem.

As shown in FIG. 3A, a device consists of a mismatched coupler with a Bragg grating written in one core over the coupling region. However, the related art can't form a long effective coupling length and has the problem of excess loss. FIG. 3B schematically shows an add-drop-multiplexer and has an effective coupling length of 2.5 mm [see “Compact All-Fiber Add-Drop-Multiplexer Using Fiber Bragg Gratings”, by Ingolf Baumann et. al., IEEE PHOTONICS TECHNOLOGY LETTERS, pp. 1331-1333, VOL. 8, NO. 10, October 1996]. However, the related art utilizes the glass as a substrate and also has the problem of excess loss. FIG. 3C schematically shows an Add-drop multiplexer, wherein the waveguides were fabricated on a Si substrate [see “An optical add-drop multiplexer with a grating-loaded directional coupler in silica waveguides” by Naoki OFUSA et. al., Third Optoelectronics and Communications Conference (OECC'98) Technical Digest, pp. 52-53, July 1998, Makuhari Messe]. However, it is hard to align the fiber with the silica waveguides.

### SUMMARY OF THE INVENTION

An object of the invention is to solve the above-mentioned problems of the related art by providing an all-fiber add/drop filter. In addition, the invention has advantages of low losses and narrow drop bandwidth.

A feature of the invention is to employ an optical fiber with a Bragg grating. Owing to multiple reflection, the invention can obtain the advantage of low losses.

Another feature of the invention is to form a V-groove on a wafer by utilizing an E-beam mask and standard microelectronic techniques. The invention can adjust the depth and radius curvature of the V-groove by the etching step to locate a side-polished fiber therein.

Another feature of the invention is to simultaneously form a plurality of V-grooves on a wafer by utilizing an E-beam mask and standard microelectronic techniques. The invention can accomplish a plurality of all-fiber add/drop filters by these V-grooves.

### BRIEF DESCRIPTION OF THE DRAWINGS

This and other objects and features of the invention will become clear from the following description, taken in conjunction with the preferred embodiments with reference to the drawings, in which:

FIG. 1A schematically shows a four-channel transmission architecture with three low-loss fiber Bragg gratings/optical circulators including one programmable add/drop multiplexer;

FIG. 1B schematically shows a hybrid DWDM device combines fiber Bragg grating and dielectric-coated band-pass filters;

FIG. 2 schematically shows an optical circuit of a 16×32 arrayed-waveguide grating;

FIG. 3A schematically shows a device consists of a mismatched coupler with a Bragg grating written in one core over the coupling region;

FIG. 3B schematically shows an add-drop-multiplexer;

FIG. 3C schematically shows an Add-drop multiplexer, wherein the waveguides were fabricated on a Si substrate;

FIG. 4 schematically shows a pattern of a mask for forming a V-groove;

FIG. 5A is a longitudinally sectional view of the Si substrate of the invention;

FIG. 5B is a cross-sectional view of the Si substrate of the invention;

FIG. 6 is a longitudinally perspective view showing the optical fiber locating in the V-groove;

FIG. 7 is a cross-sectional view showing the optical fiber located in the V-groove;

FIG. 8A schematically shows an all-fiber add/drop filter having two photosensitive fibers;

FIG. 8B schematically shows an all-fiber add/drop filter having one photosensitive fiber;

FIG. 9A is a diagram showing the operation of an all-fiber add/drop filter having one photosensitive fiber;

FIG. 9B is an operation diagram showing the operation of an all-fiber add/drop filter having two photosensitive fibers;

FIG. 10A is a diagram showing the spectrum of an all-fiber add/drop filter having one photosensitive fiber;

FIG. 10B is a diagram showing the coupling efficiency of the output ports of an all-fiber add/drop filter having one photosensitive fiber;

FIG. 10C is a diagram showing the spectrum of an all-fiber add/drop filter having two photosensitive fibers;

FIG. 11 schematically shows an all-fiber add/drop filter employing piezoelectric substrate;

FIG. 12A schematically shows an uncovered bound fibers;

FIG. 12B schematically shows an all-fiber add/drop filter having exceptional temperature stability.

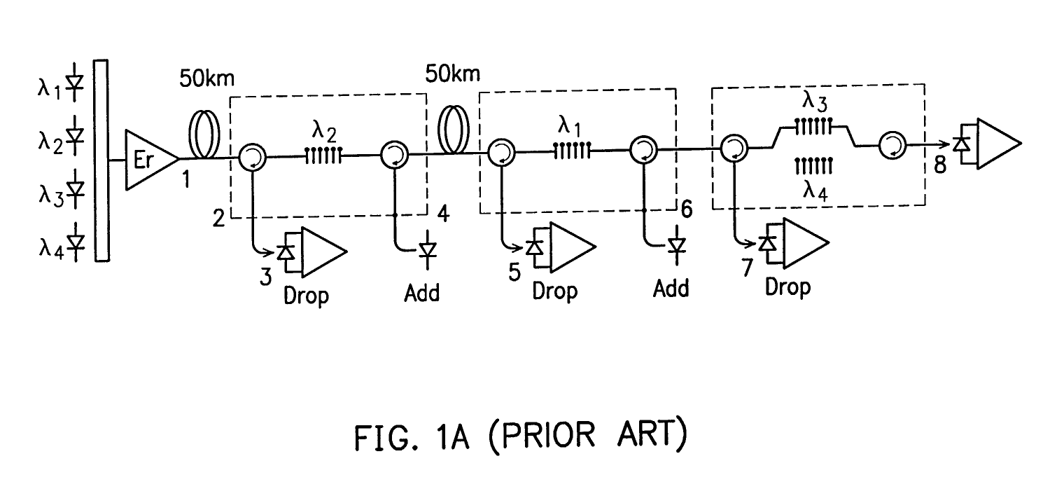

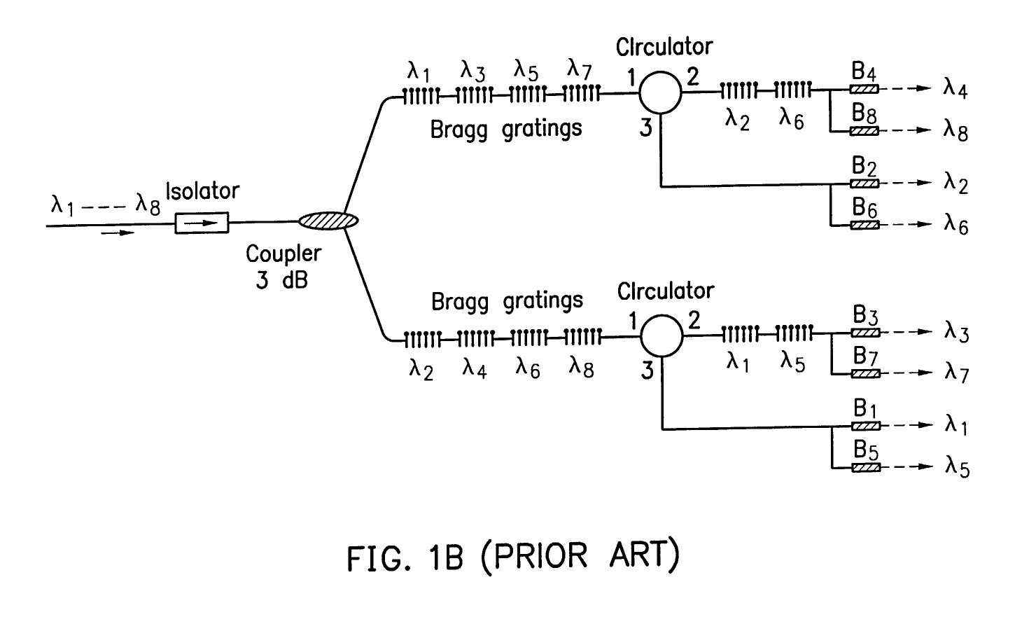

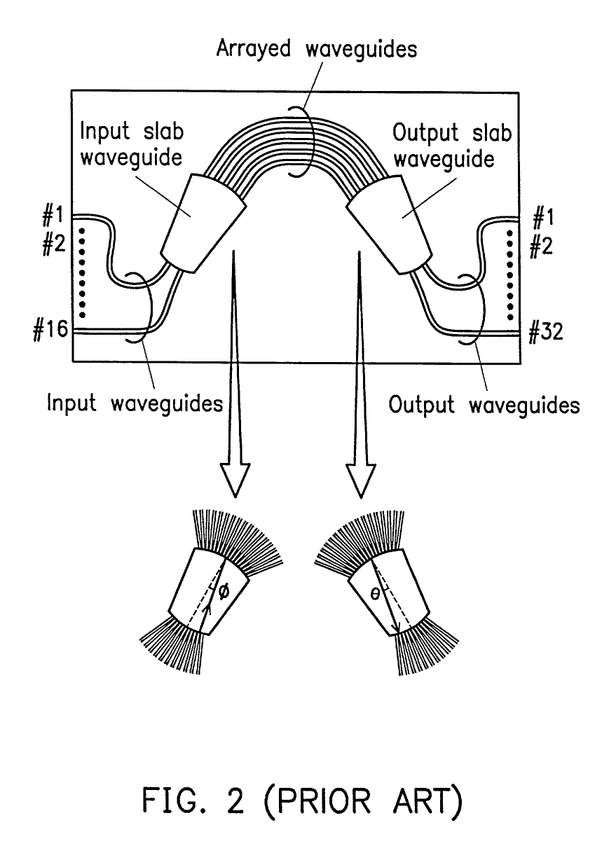

### DETAILED DESCRIPTION OF THE PREFERRED EMBODIMENT

The manufacturing method of the embodiment of the invention uses crystal orientation material, such as (100)-oriented silicon wafer of the semiconductor substrate, as the side-polishing substrate. Besides, the Si can be replaced by the quartz, glass or piezoelectric material.

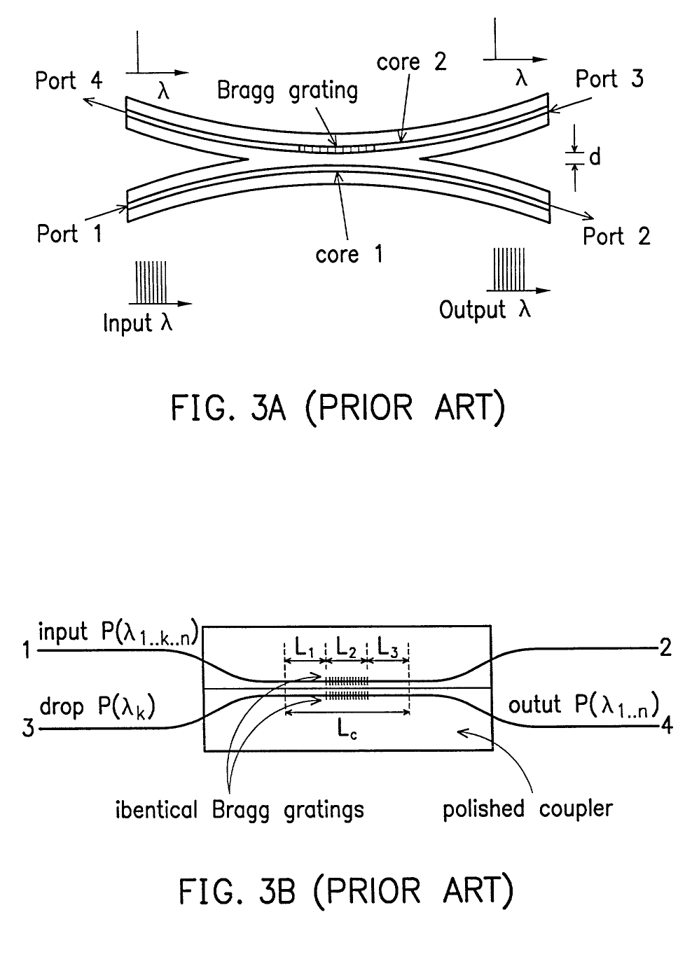

Referring to FIG. 4, the mask pattern 40 is narrow in the intermediate zone and wide at both sides. The mask pattern 40 is transferred to a Si wafer by photolithography, so that the Si wafer also forms a narrow pattern in the intermediate zone and wide in both sides. In the embodiment, it is preferred to transfer the mask pattern on the plane (100) of Si substrate.

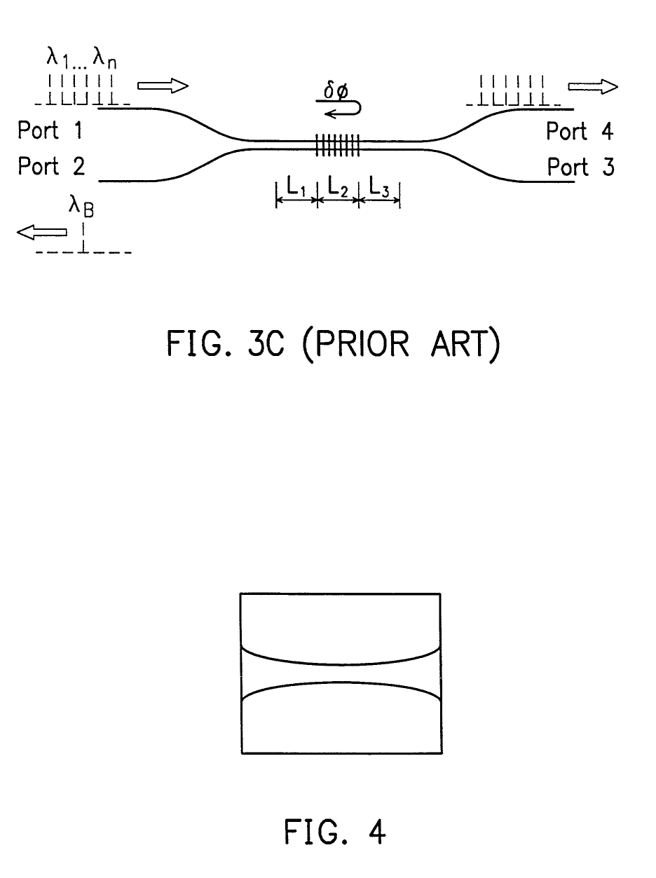

Next, referring to FIG. 5A, a V-groove 51 with long radius curvature R, such as R=1000 cm, is precisely formed on Si substrate 50 by anisotropic etching. Further, the all-fiber add/drop filter can have a long interaction region. Referring to FIG. 5B, a V-groove 51 has an included angle θ=70.53°. Moreover, a plurality of V-grooves, which have the same specification or not, are formed simultaneously by photolithography.

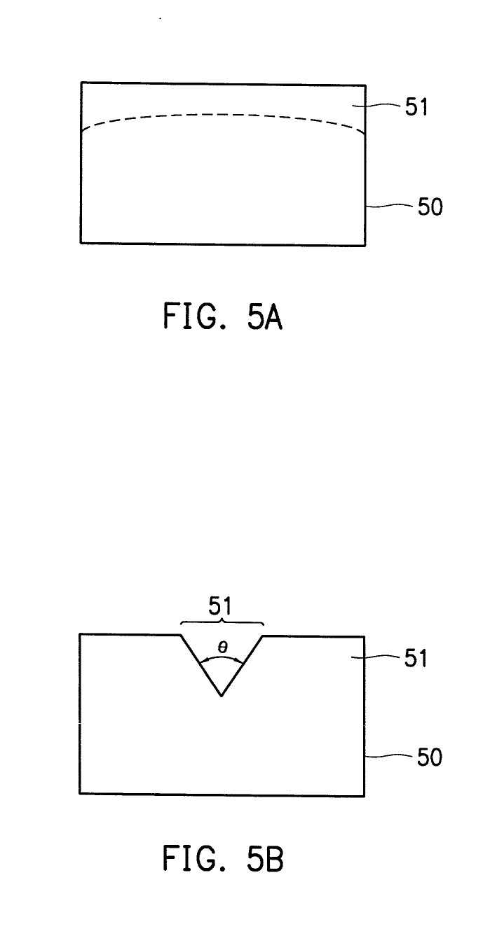

Next, glue 60 is positioned at both sides of the V-grove 51. The V-groove 51 absorbs the glue 60 from both sides by capillarity, so that the glue 60 can uniformly fill the V-groove 51. The glue 60 is an adhesive liquid and has approximate refraction index of cladding of a fiber. Next, referring to FIG. 6, an optical fiber 100 with a Bragg grating 130 is fixed in the V-groove 51. It is preferred to locate the Bragg grating 130 in the shallow region of the V-groove 51. The optical fiber 100 with the Bragg grating 130 is a photosensitive fiber.

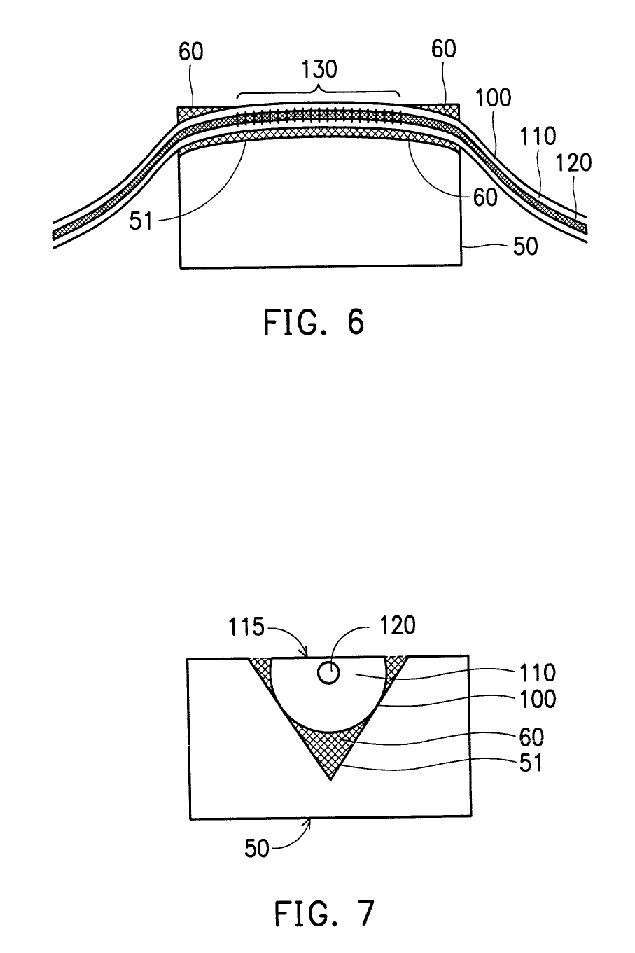

Next, polishing the cladding 110 of the fiber 100, which is higher than the Si substrate 50, forms a side-polished surface 115 contiguous to the core 120. After polishing the cladding 110, the side-polished surface 115 of the fiber 100 and the surface of Si substrate 50 have the same level. Referring to FIG. 7, the core 120 of the fiber 100 is quite near the side-polished surface 115. The smallest distance between the side-polished surface and the fiber core is about one half of the specific operation wavelength or less.

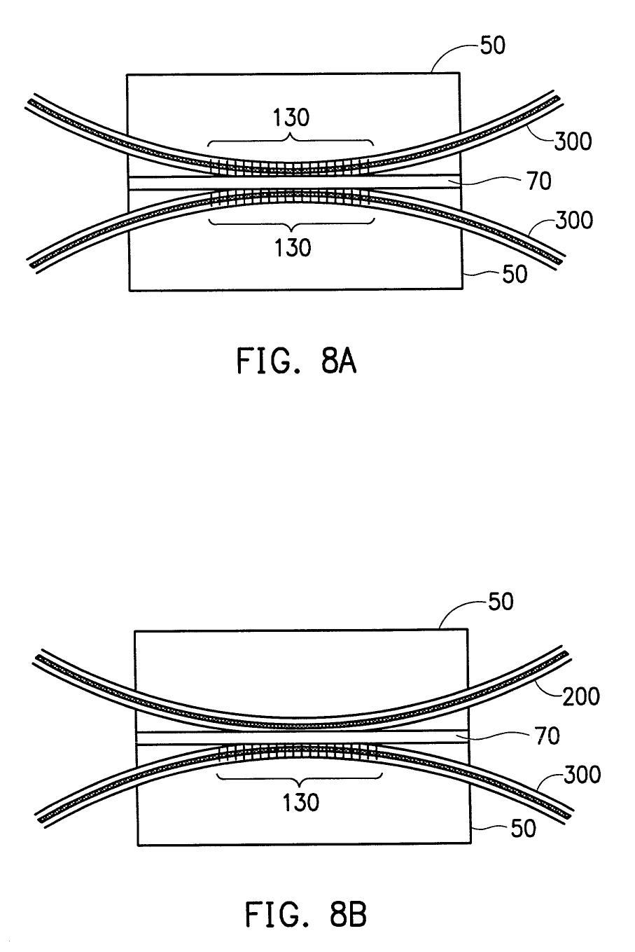

It can follow the above-mentioned steps to accomplish a fiber fixing in another V-groove. Next, referring to FIGS. 8A and 8B, the side-polished surfaces of two fibers are aligned and bound together. Further, an index matching liquid 70 is inserted between the interface of the side-polished surfaces. Referring to FIG. 8A, the side-polished surfaces of two photosensitive fibers 300 are aligned and bound together, wherein the Bragg gratings 130 in each fiber 300 exist under each side-polished surface. Referring to FIG. 8B, the side-polished surface of the photosensitive fiber 300 is aligned and bound with the side-polished surface of the ordinary (telecommunication-grade) fiber 200.

As a broadband light is injected in a photosensitive fiber, the wavelength of the broadband light satisfies the Bragg relationship

2Λ=mλ

where Λ is the grating period and m is a positive integer, such as m=1, 2, 3, . . . .As the wavelength of the broadband light including the Bragg wavelength λ propagates in the photosensitive fiber, the Bragg grating reflects the Bragg wavelength.

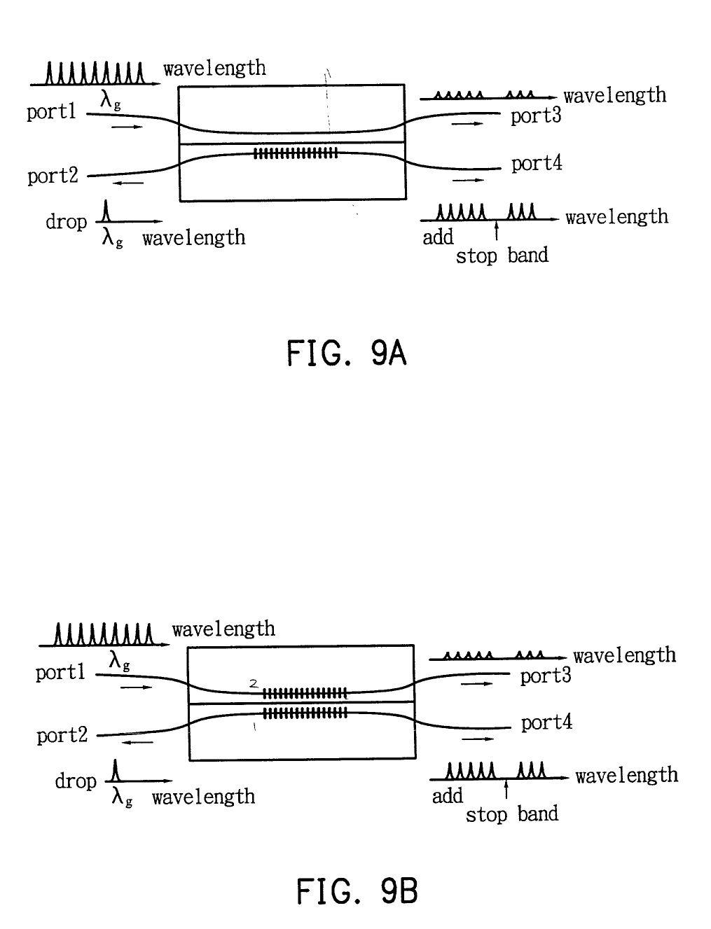

As shown in FIGS. 9A and 9B, if the port 1 is an input port and a broadband light is injected into the port 1 of the optical fiber 1, the light is coupled into the optical fiber 2. The Bragg wavelength λ_{g} included in the broadband light satisfies the Bragg relationship and is in phase to make constructive interference. Next, the Bragg wavelength λ_{g} is dropped at port 2 of the optical fiber 2. The broadband light without Bragg wavelength λ_{g} propagating through the Bragg gratings is called the transmission light. Moreover, the transmission light is also coupled into the optical fiber 2.

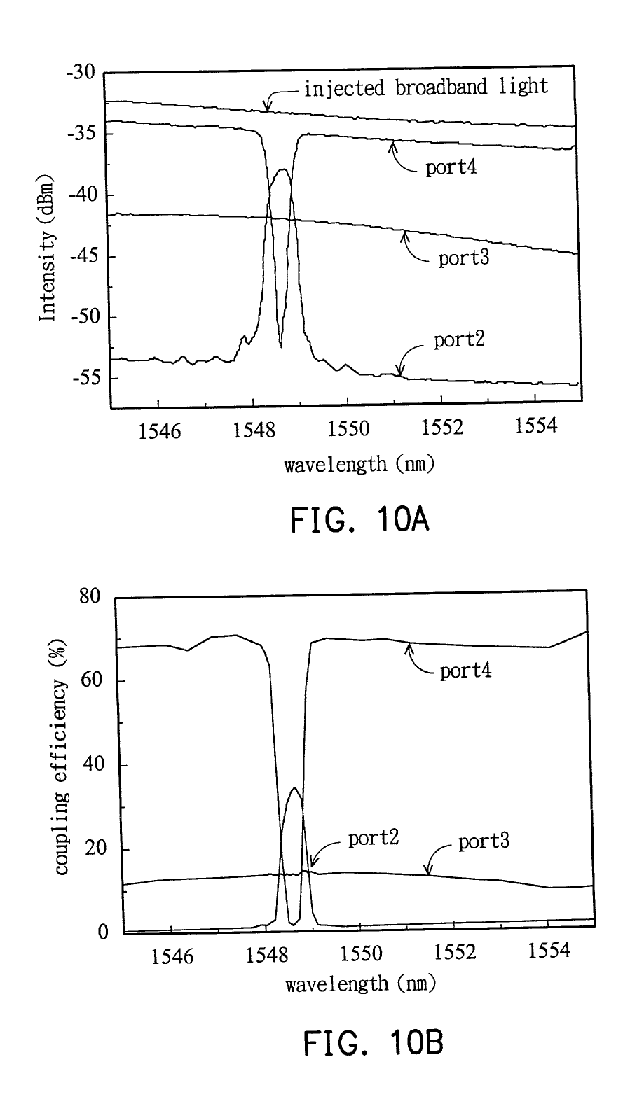

As shown in FIG. 10A, the Bragg wavelength λ_{g} measured at port 2 is 1548.6 nm. A valley shown in the transmission light at port 4 is called the stop band, wherein the wavelength of the stop band measured at port 4 is 1548.6 nm. The full width at the half maximum (FWHM) of the Bragg wavelength is about 1.14 nm, and the FWHM of the stop band is about 0.6 nm. The output spectrums of FIG. 10A are normalized to the input light power and plot in FIG. 10B. Referring to FIG. 10B, the coupling efficiency of the add channel (port 4) is about 70%, and the coupling efficiency of the drop channel (port 2) is about 30%. However, the input light power remaining un-coupled and transmitted to the port 3 is about 10%. As shown in FIG. 10C, the all-fiber add/drop filter having two photosensitive fibers improves the coupling efficiency. At port 4, the coupling efficiency is about 93%, and the FWHM is about 0.52 nm.

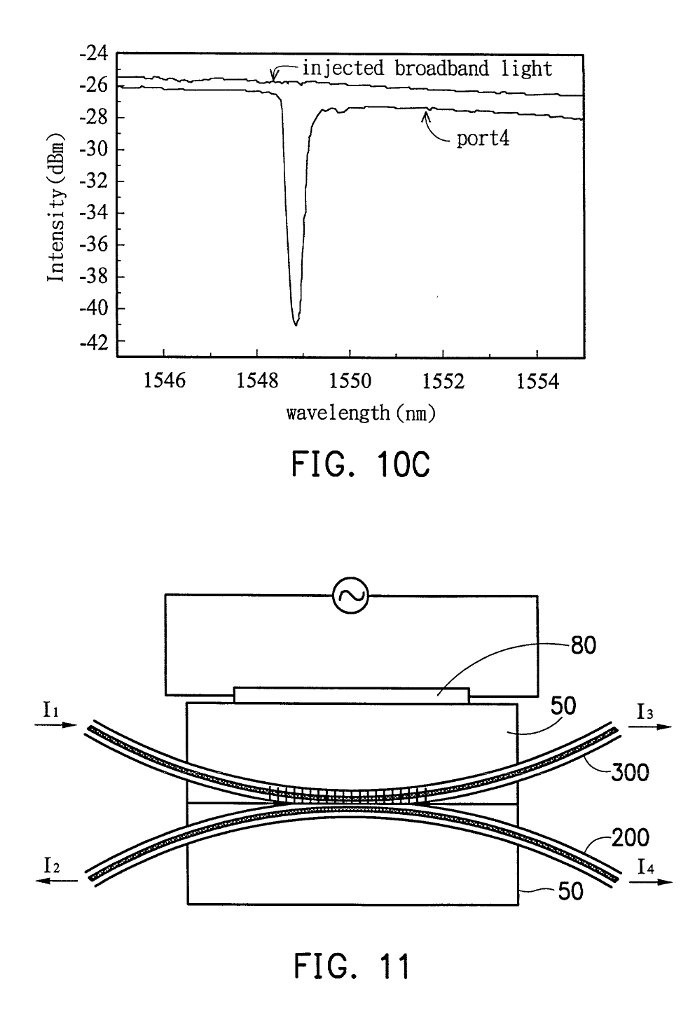

In the embodiment of the invention, the index matching liquid can be adjusted by temperature. Further, the temperature adjusts the coupling efficiency. The index matching liquid can be replaced by a material having approximate refraction index of cladding of a fiber, such as glue, air. As shown in FIG. 11, the piezoelectric material 80 is formed on the Si substrate, the injected broadband light will be modulated by applying a modulation signal on the piezoelectric material 80. Moreover, the photosensitive fiber further includes several Bragg gratings with different grating period, and then drops out several Bragg frequencies from another optical fiber.

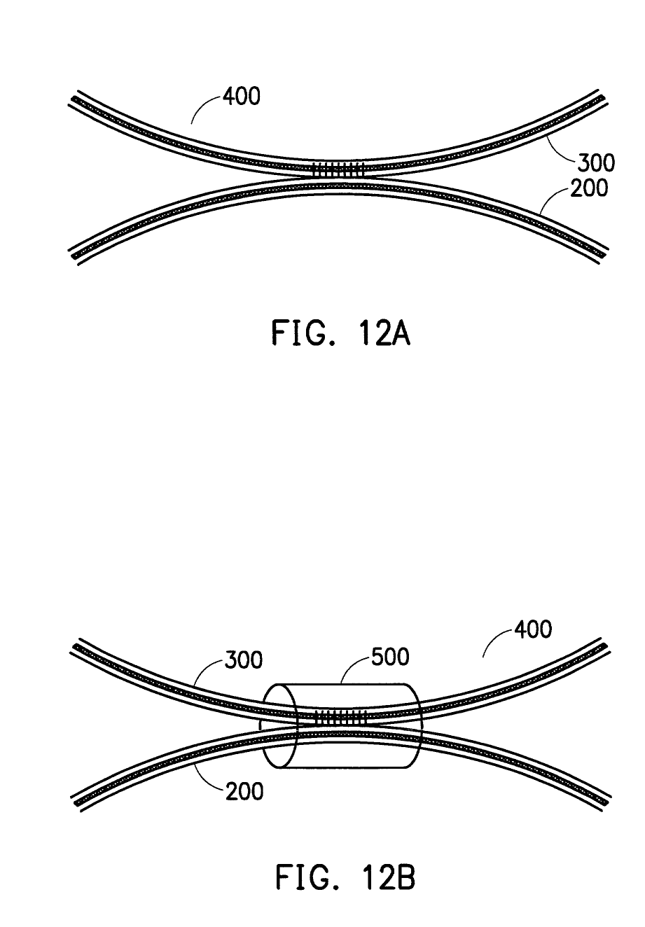

Furthermore, as shown in FIG. 12A, an uncovered bound fibers 400 is obtained by utilizing the solvent, which removes the Si substrate 50 from the photosensitive fiber 300 and the Si substrate 50 from the ordinary fiber 200. Finally, as shown in FIG. 12B, an all-fiber add/drop filter having exceptional temperature stability is formed by packaging the uncovered bound-fibers 400 by utilizing a thermally compensated material 500.

Alignment of each polished fiber can be made on silicon wafer using the standard photolithography method.

While the preferred embodiment of the present invention has been described, it is to be understood that modifications will be apparent to those skilled in the art without departing from the spirit of the invention. The scope of the invention, therefore, is to be determined solely by the following claims.

What is claimed is:

1. An all-fiber add/drop filter, comprising:
a first substrate, having a first groove with a first radius curvature;
a first optical fiber, comprising a core, a Bragg grating located at the core, a cladding for surrounding the core and the Bragg grating and a first side-polished surface contiguous to the Bragg grating and positioned in the first groove of the first substrate;
a second substrate, having a second groove with a second radius curvature; and
a second optical fiber, comprising a core, a cladding for surrounding the core and a second side-polished surface contiguous to the core and positioned in the second groove of the second substrate; wherein the first side-polished surface and the second side-polished surface are aligned and bound together.

2. The all-fiber add/drop filter as claimed in claim 1, further comprising an index matching liquid positioned between the first side-polished surface and the second side-polished surface.

3. The all-fiber add/drop filter as claimed in claim 1, further comprising glue, positioned between the first side-polished surface and the second side-polished surface.

4. The all-fiber add/drop filter as claimed in claim 1, wherein the first substrate is selected from the group consisting of semiconductor substrate, quartz, glass and piezoelectric material.

5. The all-fiber add/drop filter as claimed in claim 1, wherein the second substrate is selected from the group consisting of semiconductor substrate, quartz, glass and piezoelectric material.

6. The all-fiber add/drop filter as claimed in claim 1, further comprising glue filled the first groove and the second groove.

7. The all-fiber add/drop filter as claimed in claim 1, wherein the first optical fiber is a photosensitive fiber.

8. The all-fiber add/drop filter as claimed in claim 1, wherein the second optical fiber is a n ordinary fiber.

9. The all-fiber add/drop filter as claimed in claim 1, wherein the second optical fiber further comprises a Bragg grating located at the second groove and is a photosensitive fiber.

10. The all-fiber add/drop filter as claimed in claim 1, wherein the semiconductor substrate is a Si wafer.

11. A method of manufacturing an all-fiber add/drop filter, comprising the steps of:
forming a first groove with a first radius curvature on a first substrate;
filling the first groove with glue by absorbing glue from both sides of the first groove by capillarity;
positioning a first optical fiber in the first groove;
forming a first side-polished surface contiguous to a core by polishing a cladding of the first optical fiber;
forming a second groove with a second radius curvature on a second substrate;
filling the second groove with glue by absorbing glue from both sides of the second groove by capillarity;
positioning a second optical fiber in the second groove;
forming a second side-polished surface contiguous to a core by polishing a cladding of the second optical fiber; and
binding the first side-polished surface and the second side-polished surface together.

12. The method of manufacturing an all-fiber add/drop filter as claimed in claim 11, further comprising a step of forming an index matching liquid between the first side-polished surface and the second side-polished surface.

13. The method of manufacturing an all-fiber add/drop filter as claimed in claim 11, further comprising a step of forming glue between the first side-polished surface and the second side-polished surface.

14. The method of manufacturing an all-fiber add/drop filter as claimed in claim 11, wherein the first optical fiber is a photosensitive fiber.

15. The method of manufacturing an all-fiber add/drop filter as claimed in claim 11, wherein the second optical fiber is an ordinary fiber.

16. The method of manufacturing an all-fiber add/drop filter as claimed in claim 11, wherein the first substrate is selected from the group consisting of semiconductor substrate, quartz, glass and piezoelectric material.

17. The method of manufacturing an all-fiber add/drop filter as claimed in claim 11, wherein the second substrate is selected from the group consisting of semiconductor substrate, quartz, glass and piezoelectric material.

18. The method of manufacturing an all-fiber add/drop filter as claimed in claim 11, wherein the second optical fiber further comprises a Bragg grating locating at the second groove by replacing the ordinary fiber with the photosensitive fiber.

19. The method of manufacturing an all-fiber add/drop filter as claimed in claim 16 and 17, wherein the grooves is formed by etching the semiconductor substrate.

20. The method of manufacturing an all-fiber add/drop filter as claimed in claim 11, further comprising a step of removing the first substrate from the first optical fiber and the second substrate from the second optical fiber to obtain an uncovered bound-fibers by utilizing the solvent.

21. The method of manufacturing an all-fiber add/drop filter as claimed in claim 20, further comprising a step of packaging the uncovered bound-fibers by utilizing a thermally compensated material.
